(19) United States
(12) Patent Application Publication
(10) Pub. No.: US 2026/0338006 A1
(43) Pub. Date: Oct. 29, 2026

(54) DOUBLE LOCK MECHANISM FOR A PAWL

(71) Applicant: 2768860 Alberta Ltd., Calgary (CA)

(72) Inventor: Robert Pearce, Calgary (CA)

(21) Appl. No.: 19/490,299

(22) PCT Filed: Jun. 5, 2024
(86) PCT No.: PCT/IB2024/055488

§ 371 Date: Dec. 4, 2025

(30) Foreign Application Priority Data
Jun. 5, 2023 (CA) 3202108
Jun. 5, 2023 (CA) 3202114

(51) Int. Cl. E05B 75/00; E05B 47/00

(52) U.S. Cl. CPC E05B 75/00; E05B 2047/0056; E05B 2047/0069

(57) ABSTRACT

A double lock mechanism for a pawl is described. The mechanism comprises a double lock engaging member configured to move from a first position to a second position, and from the second position to a third position. The double lock mechanism is configured such that when the double lock engaging member is in the second position, a force is applied to return it to the first position. The double lock mechanism is disengaged in the first position, and engaged in the third position.

### FIELD

The present invention relates to restraints, their lock mechanisms, and restraints that can keep a record of their past and current state.

### BACKGROUND

A double lock mechanism of a conventional restraint, once engaged, prevents the aperture of the restraint from reducing in size. Conventional restraints such as handcuffs may include a double lock mechanism typically engaged by inserting a pin into the mechanism. The pin is often added to one end of a handcuff release/unlocking key, usually the opposite end to the one with the bit. This means that the double lock mechanism is difficult or fiddly to engage, especially when a user of the restraint may be trying to engage the double lock mechanism while the subject is resisting, for example, during an arrest. This means that the double lock mechanism may be engaged too early, meaning that the restraint aperture is too large, and the subject is able to escape the restraint, or the mechanism is engaged too late when the restraint aperture is too small and causes damage to the subject, for example by providing a large force on small bones in a subject's wrist.

Alternatively, the double lock mechanism may not be engaged at all, providing further danger to the subject, and also to the user if they restraint become so tight the user has to reset or remove the restraint.

Further, on a conventional restraint, there is no visual indication of the state of the double lock mechanism, that is, whether the double lock mechanism is engaged or not, from outside the restraint. The double lock mechanism on conventional restraints also does not provide an indication to a user when the mechanism is engaged, meaning the mechanism often has to be tested to ensure engagement, potentially causing discomfort or injury to the subject.

Conventional restraints can also injure subjects' wrists or ankles when a user applies them. Injuries may be caused by the metal or other hard part of a restraint, for example the ratchet member, contacting the subject at high speed, or a speed required to allow the ratchet to move around the pivot and to engage the pawl.

Conventional restraints when used as a pair of handcuffs are often connected using one or more chain links. The chain links allow freedom of movement of one restraint with respect to the other, but also increase the risk of a subject or user (e.g., their digits or skin) getting pinched or trapped between the chain links. Other pairs of restraints are fixed with respect to each other, or have only one degree of freedom of movement, which while reducing the risk of trapping or pinching, decreases their usability and increase the likelihood of injuries due to the subject's joints having to be repositioned to align with the restraints or cuffs.

Conventional restraints can be cumbersome or uncomfortable to handle, especially for long periods. This can cause discomfort, and in extreme cases, injury to a user. The unergonomic handling of the restraint also means that they can be difficult to apply to a subject, increasing the risk of injury to both the user and the subject.

The double lock mechanism of some restraints can be easily tampered with, either by the insertion of a shim or other probing device, or by so called “momentum attacks” where the force of the restraint hitting a solid object causes the mechanism to disengage of fail.

The usage history of a conventional restraint is often unknown. For example, it is difficult or impossible to know how many times a restraint has been used, or when it was used on a subject. Further, without external recording equipment such as video, the size of the aperture of the restraint when in use is difficult to determine. Likewise, if and when the double lock mechanism was engaged is not known for a restraint. Knowing these, and other restraint states, would allow users, subjects and third parties to audit restraints after use to determine how they were used on a subject. For example, knowing the size of the restraint aperture as a given time, whether the double lock mechanism was engaged, when the restraints were in use (for example on a subject, e.g., a perpetrator) or in a restraint holder on the user's person could provide vital information to the courts and law enforcement authorities.

### SUMMARY

According to a first aspect of the invention, there is provided a double lock mechanism for a pawl, the mechanism comprising: a double lock engaging member configured to move from a first position to a second position, and from the second position to a third position, wherein the double lock mechanism is configured such that when the double lock engaging member is in the second position, a force is applied to return it to the first position, wherein the double lock mechanism is disengaged in the first position, and engaged in the third position.

In other words, the double lock engaging member may be in the first position and the third position without a force applied to the double lock engaging member. If the double lock engaging member is in the second position, there is a force applied to it which is returning it to the first position, thus a counteracting force, e.g., from a user, is required to keep the double lock engaging member in the second position and/or move it to the third position.

The double lock mechanism may be disengaged when the double lock engaging member is in the second position. The double lock mechanism may be engaged momentarily when the double lock engaging member is moved to the second position, before the disengaging unless the double lock engaging member is moved to the third position. For example, the double lock mechanism may engage when the double lock engaging member is moved from the first position to the second position but pushes the mechanism back or returns to the disengaged position unless the double lock engaging member is moved to the third position.

An engaged double lock mechanism prevents a pawl from moving towards the double lock mechanism. The double lock mechanism may be for a pawl and ratchet mechanism, whereby at least one tooth from the ratchet may engage with the pawl, preventing the pawl from movement away from the double lock mechanism. Thus, if the double lock is engaged, and at least one ratchet tooth is engaged with the pawl, the portion comprising ratchet may not move relative to the portion comprising the pawl. The result of the arrangement when used in a restraint mechanism, for example handcuffs etc. may be that the aperture of the restraint is fixed once the double lock is engaged. The aperture may be a circle, an annulus, an oval, or any other suitable shape for encircling a longitudinal member, e.g., an arm, a write, a leg, an ankle, or a bar or other suitable object to which the restraint may be secured.

This arrangement of the double lock may provide a dual action double lock engaging mechanism, preventing, or reducing accidental engagement of the double lock. Further, the double lock mechanism may be engaged more easily by a user, for example, while using only one hand.

The force for returning the double lock engaging member to the first position when it is in the second position may be from a suitably arranged spring, a magnet, or by the force applied by a finger of a hand while holding a restraint comprising the mechanism.

The angle between a path between the first position and the second position and a path between the second position and the third position may be less than 180°.

The angle between the path between the first position and the second position and the path between the second position and the third position may be less than or equal to, 135°, 90°, 45°. The angle may be greater or equal to than 10°.

In the first position, the double lock engaging member may be able to move to the second position but may not be able to move to the third position. In the second position, the double lock engaging member may be able to move to the first or third position. In the third position, the double lock engaging member may be able to move to the second position but may not be able to the first position.

That is, the action of moving the double lock engaging member from the second position to the third position engages the double lock. Once the double lock is engaged, the pawl cannot be moved onto a new or different ratchet tooth.

The double lock engaging member can move from the first position to the second position, but not directly from the first position to the third position. That is, to move the double lock engaging member from the first position to the third position, the double lock engaging member has to be moved first to the second position. In the second position, the double lock engaging member can move directly to the first or third position. In the third position, the double lock engaging member can move directly to the second position, but cannot move directly to the first position, that is, to move the double lock engaging member to the first position from the third position, the double lock engaging member has to be moved first to the second position.

The double lock mechanism may be for a pawl and ratchet mechanism.

This double lock mechanism therefore provides a mechanism that requires two actions to engage the double lock, thus reducing or eliminating the accidental engagement of the double lock mechanism.

The double lock engaging member may comprise an anti-interference structure configured to prevent unauthorised interference with the double lock mechanism.

The anti-interference structure may be a block or blocking member or a false tunnel). Unauthorised interference may include, for example, a shim being inserted into the double lock mechanism to disengage the mechanism. The double lock engaging member may comprise more than one block or blocking member. The anti-interference structure may be a false tunnel which directs a shim away from where it could interfere with the engaging member.

The mechanism may comprise a slider having disengaged and engaged positions, wherein in the disengaged position the double lock mechanism is not engaged and in the engaged position the double lock mechanism is engaged, wherein the double lock engaging member is configured to move the slider into the engaged position when it is moved from the second position to the third position.

The slider may be in the disengaged positions when the double lock engaging member is in the first and second positions.

The slider may be a separate component to the double lock engaging member. This may allow the double lock engaging member to move independently from the slider. Thus, if a person removes the double lock engaging member, for example by force, the slider remains in place, and if engaged, the double lock mechanism remains engaged.

The slider may be “L” shaped, or predominantly “L” shaped. The slider may have key-engaging protrusions along the length of the “L”. The “L” shape may decrease the likelihood of the slider being bent, for example, after many uses. The slider may have second key-engaging protrusions which can engage with a key when a key is inserted into the keyhole and rotated. Rotating the key to engage with the second protrusions can also move the slider into the engaged position.

The mechanism may comprise a detent configured to retain the slider in the engaged and/or disengaged positions.

The mechanism may comprise a detent configured to retain the double lock engaging member in the first and/or third position.

The detent may be a mechanical detent, or a magnetic detent. The detent may be or comprise a ballnose plunger or a spring plunger. The detent may comprise a spring. The double lock engaging member may comprise a detent receiving portion, for example a recess, or a magnetic material. The detent may comprise a ball detent.

The mechanism may be configured to generate a sound when the double lock engaging member is moved into the third position.

The sound may be, for example, a click, a beep, a snap, a clack, or a clink. Thus, there is an audible indication that the double lock has been engaged. There may be haptic feedback provided to a user when the double lock engaging member is moved into the third position.

The double lock mechanism may be arranged between first and second sheets or arranged within a casing or sleeve.

The sheets may be part of, or form part of, cheeks of a restraint.

The double lock engaging member may be arranged to protrude from at least one of the first or second sheets when in the first or second positions and may be arranged to be recessed between the first and second sheets when in the third position.

Thus, there is a quick visible indication from multiple angles of the sheets containing the double lock mechanism as to whether the double lock is engaged or not.

The double lock engaging member may protrude from an edge of the sheet, or may protrude through either the first or second sheet.

There may be a restraint mechanism comprising the double lock mechanism.

The restraint mechanism may comprise a ratchet portion, the ratchet portion comprising at least one ratchet tooth.

There may be a restraint comprising the restraint mechanism.

The restraint may be a cuff restraint, a manacle, a fetter, a wrist restraint, or handcuff, an ankle restraint, or ankle or leg cuff, or a shackle.

According to a second aspect of the invention, there may be a restraint comprising the mechanism of the first aspect, the restraint comprising: a first member connected to a second member at a pivot, the first and second members configured to engage with each other to form an aperture.

The first and second members can engage when the double lock mechanism is not engaged. If the first and second members are engaged to form an aperture, the double lock mechanism can be engaged to prevent the disengagement of the first and second members. If the first and second members are not engaged, the double lock mechanism may prevent the engagement of the first and second members.

The first and/or second sheet may comprise an aperture for a key, wherein the slider is configured to move from the engaged position to the disengaged position upon rotation of a key inserted into the aperture.

The restraint may comprise a pawl, the pawl may be configured to disengage with a ratchet upon rotation of a key inserted into the aperture.

The rotation to disengage the slider and the pawl may be in the same or opposite directions.

According to a third aspect of the invention, there may be a pair of restraints comprising first and second restraints according to the second aspect connected to each other.

The first and second restrains may be connected by a connector. The connector may comprise first and/or second cables.

According to a fourth aspect of the invention, there is provided a restraint for applying to a wrist or an ankle comprising a sensor configured to detect or determine when the restraint is in use.

Detecting when the restraint is in use may comprise determining the use status of the restraint.

The sensor may be a capacitive touch sensor which may detect the presence or absence of touch (i.e., the restraints or cuffs are held by a user or touching a subject or are no longer held by a user or applied to a subject). That is, the sensor may detect the restraint is in use when the capacitive touch sensor detects a touch, for example, from a user or a subject. The sensor may be a sensor configured to detect when the restraint is removed from a restraint holder. The sensor may be a sensor that detects movements in the restraint, for example a sensor which detects movement of a ratchet member of the restraint about a pivot point where it is attached to a second member. The sensor may be a sensor that detects movement in the locking mechanism of the restraint, for example, the double lock mechanism, or the ratchet and pawl mechanism. The sensor may be an accelerometer, a gyroscope, or an inertial measurement unit (IMU) configured to detect movement of the restraint.

The restraint may further comprise a first member connected to a second member at a pivot, the first and second member configured to engage with each other to form an aperture. The aperture may be a circle, an annulus, an oval, or any other suitable shape for encircling a longitudinal member, e.g., an arm, a write, a leg, an ankle, or a bar or other suitable object to which the restraint may be secured.

The sensor may be configured to detect movement of the first member with respect to the second member.

Thus, the sensor can determine movement of the restraint, e.g. whether the first member moves with respect to the second member can be determined, and/or the length of the perimeter of the aperture, (or if circular, the diameter or radius of the aperture) of the restraint (e.g. a manacle, or handcuff) can be determined. The length of the external perimeter of the restraint may also be determined.

The sensor may be arranged around or adjacent to the pivot. The sensor may be a magnetic sensor, for example, a Hall Effect switch, a Hall Effect latch, a magnetoresistive sensor, or a reed switch. The sensor may be a potentiometer-based sensor, the sensor may be a rotary encoder, the sensor may be a rotary inductive encoder. The sensor may be a rotary variable differential transformer. Thus, the restraint may be operated at extremely low power as magnetoresistive sensors may be operated at extremely low power. Preferably the magnetoresistive sensor is a tunnelling magnetoresitive sensor.

Alternatively, or additionally, the sensor may be configured to count the number of ratchet teeth have moved past the pawl, thus detecting movement in the restraint, or using the tooth count to determine the size of the aperture. The sensor may sense motion of the pawl as it oscillates up and down as is engages the teeth of the ratchet, rather than the rotation of the ratchet about the aperture. The sensor may be a magnetic sensor arranged to be in, or close to, the ratchet or the pawl and configured to detect movement of either the ratchet or the pawl. The sensor may comprise an embedded magnet(s) or use induction to detect the metal of a ratchet (first member) teeth as they pass by a pawl. The sensor may be an optical sensor configured to detect the movement of one or more parts of the restraint mechanism.

The sensor may be configured to detect the angle of rotation of the first member with respect to the second member.

The sensor may comprise a capacitive touch sensor configured to detect the presence or absence of the touch of a user.

The capacitive touch sensor may be configured to detect the presence or absence of a subject, for example a perpetrator.

The sensor may be a sensor configured to detect movement of a component of the restraint.

The restraint may further comprise a double lock engaging member for a double lock mechanism for a pawl, wherein the sensor is configured to detect movement of the double lock engaging member.

The sensor for detecting movement of a double lock engaging member may be a magnetic sensor which senses the strength of a magnet comprised within the engaging member. If the engaging member moves closer to or further away from the magnetic sensor, the movement is detected.

The sensor may comprise an accelerometer. The sensor may comprise a gyroscope. The sensor may comprise an inertial measuring unit. Thus, the sensor may be able to determine the movement of the restraint during use, for example, by obtaining accelerometer, inertia, or gyroscopic information (e.g., angular velocity). The restraint may further comprise a processor for processing the data received from one or more of the sensors to determine whether the restraint is in use, or whether the restraint is being carried before deployment or use, for example, in a restraint holder or holster.

The sensor may be configured to detect when the restraint is removed from a restraint holder.

The sensor may detect the presence, absence, or strength of a magnetic field, or comprise a circuit breaker. The sensor may be a radio communication sensor (e.g., a Bluetooth™ sensor), or other suitable proximity sensor. The sensor may be low powered.

The sensor may be near field communication sensor, or a radio frequency identification sensor.

The restraint may comprise a controller; a timer; and memory, wherein the controller may be configured to, on detection that the restraint is in use or has been removed from the restraint holder, to record the time.

The controller may be a microcontroller. The controller may also record the time the restraint was no longer in use, for example, when one of more of the sensors indicates that the restraints are no longer in use, e.g., when they are no longer in contact with a subject's skin, or are no longer being held by a user. That is, the time may be recorded for each state change, for example, when the restraint started to be in use (e.g., by being notified by one or more sensors), and when the restraint was no longer in use (e.g., a pre-determined period of time has passed).

The controller may comprise a processor, the processor may be configured to receive inputs from one or more sensors, and output a restraint state based on the inputs.

The restraint state may be binary, e.g., on or off, the restraint state may indicate whether particular components are in use (e.g., on or off), for example, that the ratchet has not moved for 10 minutes, and that the double lock mechanism has been engaged for 9 minutes 30 seconds, or that the third tooth of the ratchet is engaged with the pawl, or that the restraint was last touched less than 30 seconds ago.

The sensor may comprise a magnetic sensor configured to detect a magnetic field.

The presence of a magnetic field may affect the circuit of the restraint, for example, by providing incorrect readings, phantom sensor readings, blocking sensor readings, or interfering with the circuit in a way that means the circuit is not functioning as intended. The detection of a magnetic field near the restraint may be recorded so that a time of possible interference can be recorded. The detection of the magnetic field may indicate that a user, or a third party, is attempting to interfere with the restraint. The controller may be configured to receive a signal from the sensor, and to record that an interfering magnetic field has been detected.

On detection that the restraint is removed from the restraint holder, the restraint may be configured to record the output of one or more sensors comprised within the restraint.

The controller may stop recording events form the one or more sensors, the magnetic sensors when the one or more sensors stops detecting skin contact, e.g., through capacitive change.

The or a sensor, e.g., a magnetic sensor or a capacitive touch sensor, may be used to detect that the restraints are in use again, and begin recording the output from the one or more sensors again.

The restraint may comprise a first member connected to a second member at a pivot, the first and second members configured to engage with each other to form an aperture; and a controller, wherein the sensor is configured to detect the angle of rotation of the first member with respect to the second member.

Thus, the diameter or radius of the aperture of the restraint (e.g., a manacle, or handcuff) can be determined.

The controller may be a microcontroller.

The sensor may be a magnetic sensor, for example, a Hall Effect switch, a Hall Effect latch, a magnetoresistive sensor, or a reed switch. The sensor may be a potentiometer-based sensor, the sensor may be a rotary encoder, the sensor may be a rotary inductive encoder. The sensor may be a rotary variable differential transformer. Thus, the restraint may be operated at extremely low power as magnetoresistive sensors may be operated at extremely low power. Preferably the magnetoresistive sensor is a tunnelling magnetoresitive sensor.

According to a fifth aspect of the invention, there is provided a double lock mechanism for a pawl comprising: a slider having disengaged and engaged positions, wherein in the disengaged position the double lock is not engaged and in the engaged position the double lock is engaged; and a sensor configured to determine whether the slider is in the engaged or disengaged position.

The sensor may be a proximity sensor. The sensor may be a magnetic sensor may be, for example, a Hall Effect switch, a Hall Effect latch, a magnetoresistive sensor, or a reed switch. The sensor may be an inductive sensor or switch, an optical sensor or switch, or a mechanical sensor or switch.

The restraint of the first or second aspect may comprise memory configured to store the output of the sensor.

Thus, the diameter of the aperture of the restraint, when the restraint was touched by a user, or when the restraint was removed from a restraint holder, or when the double lock was engaged or not engaged may all be recorded and stored on the restraint for inspection later, for example, by a court or auditor. There may be a wireless interface for sending the data recorded from the sensor(s) to a device, for example, a computer, or a server, for example, a cloud server.

According to a sixth aspect of the invention, there is provided a ratchet-and-pawl mechanism for a restraint, the mechanism may comprise: a pawl having a ratchet engaging end and a pivot end; a first member comprising at least one ratchet tooth configured to engage with the ratchet engaging end of the pawl; and a pocket for receiving the pawl pivot end, wherein the pocket is configured to allow the ratchet engaging end to move along an arc.

Thus, the ware on the pawl around the pivot may be reduced, meaning that the life of the mechanism, or time between servicing and/or repair may be increased. For example, if a pivot pin were to get bent, the whole mechanism could jam up or feel very rough to use. The pawl pivot end may not have a pin or axel around which the pawl rotates. The pivot end of the pawl may engage with the wall of the pocket. Further, if a third-party attempts to compromise the restraint, for example, by pulling on the restraint such that the ratchet teeth engage the pawl, this action may pull on the pawl rotation/pivot point and could bend or break any pawl pivot pin present, for example, by snapping the pin. By removing the pivot pin, the structural strength of the restraint may be increased.

The pocket may allow the pawl to rotate between first and second angles with respect to the pocket in a plane.

The arc the ratchet engaging end can rotate along is defined by the position of the pivot end of the pawl, and the width of the pocket.

The ratchet-and-pawl mechanism may comprise: a second member comprising the pocket; a connecting member connecting the first member and the second member at a pivot, wherein the first and second members are configured to engage with each other to form an aperture.

Thus, a handcuff is formed comprising the ratchet-and-pawl mechanism.

According to a seventh aspect of the invention, there is provided a pair of restraints, each restraint configured to form an aperture and each restraint connected by first and second cables.

The aperture may be any suitable shape that allows for the restraint to encircle the body part or object to which the restraint is being applied.

The use of first and second cables eliminates or reduces the possibility of a wearer of the restrains being pinched between the chain of a traditional restraint (e.g., a pair of handcuffs) and the cuff body.

A pair of restraints with this configuration may allow the restraints or cuffs to rotate and bend relative to one another and may also provide a small spring force which returns the restraints or cuffs to the default position.

This may allow a user (e.g., a law enforcement officer) to move the second restraint or cuff to a subject's wrist rather than move the wrist to the restraint or cuff as is necessary with hinged handcuffs. Such an action using hinged cuffs or restraints may injure the subject. The spring force may also make the location of each of the cuffs or restraints predictable while still allowing them to bend and rotate relative to one another.

Each restraint of the pair of restraints may comprise: a first member connected to a second member at a pivot, the first and second members configured to engage with each other to form an aperture.

The first and second cables may comprise metal fibres.

The first and second cables may comprise woven polymer. The cables may comprise metal rope. The metal may be steel. The cable may be multi-strand cable, for example, wire rope.

The first and second cables may be substantially parallel to each other.

The first and second cables may be connected to each other along their length by a connector.

The connector may be a steel connector or clamp. The connector may pinch the cables together to form an hour-glass shape. The use of these cables may also prevent unintended twisting of each restraint with respect to each other.

The first and second cables may be coated in a polymer.

The polymer coating may be, for example, polyvinyl chloride (PVC), nylon (polyamide), fluorinated ethylene propylene (FEP), polyurethane, polyethylene, polytetrafluoroethylene (PTFE), or other suitable polymers. Thus, the coating may reduce or prevent fraying of the cable, and provide a smooth surface which is less prone to snagging.

According to an eighth aspect of the invention, there is provided a pair of restraints connected by a spring.

That is, the pair of restraints may be connected to each other by the spring. The spring may comprise a spring sheet. The spring may comprise spring plate or a spring bar. The spring may be a leaf spring comprising overlapping layers of spring sheets.

The spring sheet may be a spring-steel sheet. The spring may be encased in a sheath, for example a polymer sheath, for example, silicone, nylon (polyamide), or polyvinyl chloride(PVC). However, other suitable coatings may be used, for example, fluorinated ethylene propylene (FEP), polyurethane, polyethylene, polytetrafluoroethylene (PTFE), or other suitable polymers.

The first and second cables or spring may be configured to provide a force such that the plane of the aperture of the first restraint is less than or equal to 15° from the plane of the aperture formed by the second restraint.

The angle between the plans of the apertures of the first and second restraints may be less than or equal to 10°, 8°, 5°, or the angle may be equal to 0°, that is, the apertures are on the same plane.

Thus, when a user applies a first restraint to a wrist, ankle, by letting go of the second restraint, the cables or spring move the second restraint into a position which may allow for easy attachment to the second wrist or ankle. Thus, the risk of injury to the user and the subject is reduced as the user does not have to retrieve the second restraint and bring it into the appropriate position. Likewise, if the subject is struggling, the user may have to use their hands to restrain the subject and thus may be unable to move the second restraint into position. When using restraints connected by a chain, there is an increased risk of the user and/or subject's skin being pinched while manipulating the restraints.

The pair of restraints may be configured to provide a force such that the plane of the aperture of the first restraint is less than or equal to 15° from the plane of the aperture formed by the second restraint while no external force is being applied to either the first or second restraint, for example, by a user manipulating one of the restraints.

The force that returns the restraints to a roughly “flat” orientation (where the apertures lie in the same plane), may also allow for the restraints to be stored folded against each other, as they will return to a usable orientation when removed from a holder or storage for use.

Thus, the pair of restraints have a predictable position with respect to each other and allow the safe and efficient fitting of the restraint to, for example, a pair of wrists.

According to a ninth aspect of the invention, there is provided a restraint comprising: a first member connected to a second member at a pivot, the first member configured to engage the second member to form an aperture, wherein at least part of the first member comprises padding.

The pivot may comprise a pivot pin. The engagement may be a secure engagement, for example, preventing disengagement in at least one direction. The padding may be foam or gel padding.

The first member may comprise first and second sections, wherein the first section comprises a ratchet tooth, wherein the second member is configured to receive or comprises a pawl, the pawl configured to engage with the ratchet tooth, and wherein the second section of the first member comprises the padding.

The padding may be formed on the outside of the aperture.

Thus, the padding on the outside/external part of the restraint provides protection to the person or animal being restrained when administering the restraint. The padding may comprise polyurethane.

According to an tenth aspect of the invention, there may be provided a restraint comprising: a first member connected to a second member at a pivot; and a non-metallic cheek plate attached to the second member.

The non-metallic material may comprise or consist of carbon fibre. There may be a second cheek. The second cheek may be attached to the second member. The second member may comprise first and second plates, which may be respectively attached to first and second cheeks. The second member may comprise or consist of a non-metallic material, for example carbon fibre. The cheek plate may comprise or consist of carbon fibre.

The carbon fibre may be a carbon fibre composite. For example, a polyamide. The carbon fibre may have short, non-woven carbon fibres. The carbon fibre may be woven carbon fibre.

The restraint may comprise a bracket attached to the cheek, the bracket configured to house a pawl, the pawl configured to engage with the first member, wherein the bracket comprises a non-metallic component.

The bracket may be interposed between the first and second cheek. The non-metallic component may comprise carbon fibre, plastic, acrylonitrile butadiene styrene (ABS), or bioplastic. The non-metallic component may consist of carbon fibre.

The bracket may be arranged between first and second plates of metal, also referred to as “cheeks”. Each cheek may be attached to the second member.

The bracket, or middle layer of the restraint, is subject to less stress than the first and second members, or the first and second cheeks (if present) and can therefore be made from lighter material with less strength.

According to an eleventh aspect of the invention, there is provided a restraint comprising: a first member connected to a second member at a pivot, the first member configured to engage the second member to form an aperture, wherein the first member comprises a solid plate and the second member comprises a skeletonised plate or a scaffolded plate.

That is, the second member may comprise a plate with shapes, for example triangles, removed from it, forming a skeletonized, or scaffold-like structure. The second member may comprise a series of linear or curves struts connected at nodes to form a skeletonized or scaffold-like structure.

According to a twelth aspect of the invention, there is provided a restraint comprising: a first member having first and second ends; a second member having first and second ends; wherein the second ends of the first and second members are connected to each other at a pivot, and the first ends of the first and second members are configured to engage with each other to form an aperture, wherein the first member comprises a recess suitable for receiving an index finger between first and second ends, wherein the first end of the second member comprises a restraint cheek, the restraint cheek comprising first and second ends, the first end of the constraint cheek comprising first and second recesses suitable for receiving an index finger and a middle finger respectively, the second end comprising a recess suitable for receiving a thumb.

The first member may have first and second ends, the first end may comprise at least one ratchet tooth. The second member may have first and second ends, the first end may be configured to receive a pawl, or attached to a bracket configured to receive a pawl, the pawl configured to engage with the at least one tooth of the first member. The second ends of the first and second members may be connected at a pivot, for example, by a pin, a screw, a rivet and the like.

Thus, the restraint has an ergonomic design which may be easier for a user to hold securely, reducing the risk of the restraint being removed from the user by force, or being used as a weapon against the user. Further, the index finger may be free to engage the button, the ratchet teeth, and/or the concave section of the first member, that is, the section opposite the ratchet teeth of the first member. Such a configuration allows the easy manipulation of the restraint. The configuration also allows for a reduction in stress on the hand manipulating the restraint, reducing the chances of injury.

The first and second recesses suitable for receiving an index finger and a middle finger respectively may be adjacent to each other.

### BRIEF DESCRIPTION OF THE DRAWINGS

Certain embodiments of the present invention will now be described, by way of example, with reference to the accompanying drawings, in which:

FIG. 1 is a cross-section of a ratchet and pawl restraint with a disengaged double lock mechanism;

FIG. 2 is a cross-section of a ratchet and pawl restraint with a disengaged double lock mechanism, and the pawl disengaged from the ratchet;

FIG. 3 is a cross-section of a ratchet and pawl restraint with a disengaged double lock mechanism;

FIG. 4 is a cross-section of a ratchet and pawl restraint with an engaged double lock mechanism;

FIG. 5 is an illustration of a of a ratchet and pawl restraint with an engaged double lock mechanism;

FIG. 6 is a perspective view of the ratchet and pawl restraint of FIG. 5;

FIG. 7 is a photograph of a restraint with a disengaged double lock mechanism;

FIG. 8 is an illustration of a pair of restraints connected by first and second cables;

FIG. 9 is an illustration of a pair of restraints connected by a spring;

FIG. 10 is an illustration of a pair of restraints connected by chain links;

FIG. 11 is a first photograph of the pair of restraints connected by first and second cables in FIG. 8;

FIG. 12 is a second photograph of the pair of restraints connected by first and second cables in FIG. 8;

FIG. 13 is a photograph of the first and second cables of the pair of restraints in FIG. 8;

FIG. 14A to 14C are illustrations of digit placement while holding a restraint;

FIG. 15 is a photograph of a restraint portion including a circuit and a battery;

FIG. 16 is a render of a restraint and a cut-away of a restraint showing a circuit and battery;

FIG. 17 is a system block diagram of circuitry of a restraint;

FIG. 18 is a render of a first moulding on a ratchet portion of a restraint;

FIG. 19 is a render of a second moulding on a ratchet portion of a restraint;

FIG. 20 is a photograph of the second moulding of ratchet portion of a restraint of FIG. 19;

FIG. 21 is a photograph of a restraint comprising a moulding;

FIG. 22 is a photograph of a partially skeletonized restraint; and

FIG. 23 is a cross-section of a ratchet and pawl restraint with an engaged double lock mechanism with a c combined slider and engaging button.

### DETAILED DESCRIPTION OF CERTAIN EMBODIMENTS

### Restraint

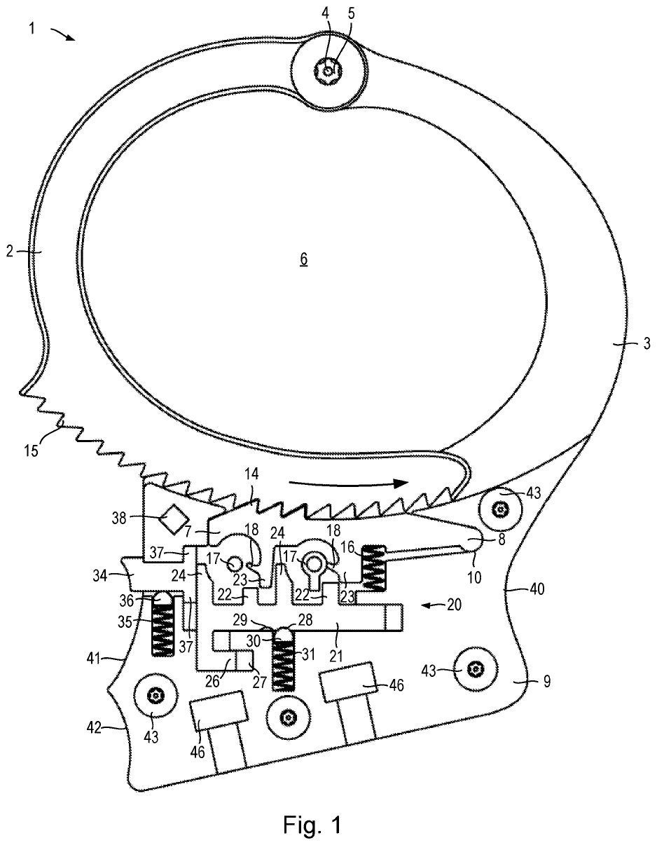

Referring to FIG. 1, a restraint 1, for example a handcuff is shown. The restraint 1 has a first member 2 (or “ratchet”) and a second member 3 connected to each other at a pivot point 4 using a pin 5 and fastener. The first and second members 2, 3 are configured to engage with each other to form an aperture 6. The restraint 1 is suitable for attaching to a wrist or ankle of a subject (also referred to as person), where the wrist or ankle would go through the aperture 6 formed by the restraint 1. The restraint 1 is also suitable for being attached to an appropriately sized solid object, for example, a bar, or a tube. The pivot 4 allows the first and second members 2, 3 to be moved to an angle relative to each other that would break the aperture 6 and therefore may allow for the release of the wrist or ankle, or another object. The restraint 1 may be, or be used as a component of, a handcuff, an ankle cuff, a manacle, a shackle, a fetter, and the like, or pairs of the same.

### Pawl and Ratchet

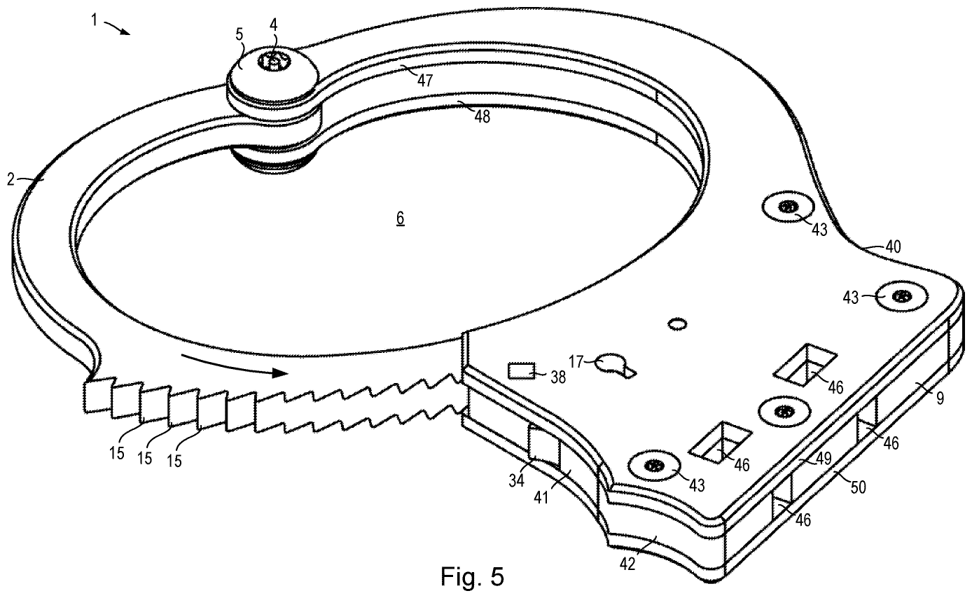

The second member 3 may comprise or be attached to a pawl 7 and pawl pivot 8 mechanism. The pawl 7 and pawl pivot 8 mechanism may be housed in a bracket 9 sandwiched between first and second cheeks (see FIG. 5). The pawl pivot 8 may be a free-floating pivot, that is, the bracket 9 may form a pivot pocket 10 which may take the form of a “U” shape or rounded “V” shape for receiving a similarly rounded end of the pawl 7. If the pawl is a free-floating pawl, there is no pivot pin in the pawl pivot 8. The pawl pocket 10 is shaped in such a say to allow the pawl 7 to rotate about the pawl pivot 8 between first and second angles, which may be less than or equal to 20°, 15°, 10°, 5°, or 4° apart. The first and second cheeks (not shown in FIG. 1, but see FIG. 5) may be arranged to prevent movement of the pawl 7 away from the plane of movement of the first and second members 2, 3.

Thus, the wear on the pawl around the pivot may be reduced, meaning that the life of the mechanism, or time between servicing and/or repair may be increased. For example, if a pivot pin were to get bent, the whole mechanism could jam up or feel very rough to use. The pawl pivot end may not have a pin or axel around which the pawl rotates. The pivot end of the pawl may engage with the wall of the pocket.

Further, if a third-party attempts to compromise the restraint, for example, by pulling on the restraint such that the ratchet teeth engage the pawl, this action may pull on the pawl rotation/pivot point and could bend or break any pawl pivot pin present, for example, by snapping the pin. By removing the pivot pin, the structural strength of the restraint may be increased.

The pocket may allow the pawl to rotate between first and second angles with respect to the pocket in a plane.

The arc the ratchet engaging end can rotate along is defined by the position of the pivot end of the pawl, and the width of the pocket.

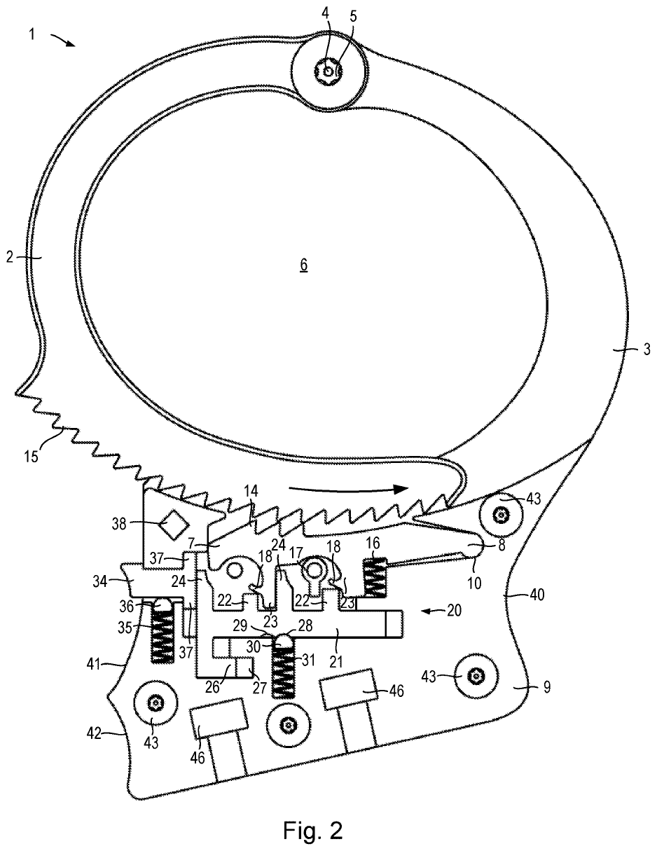

Referring also to FIG. 2, the pawl 7 has one or more teeth 14, each tooth 14 may engage with one or more corresponding teeth 15 on the outer edge of the first member 2. The teeth 15 of the first member 2 are arranged so that when they engage a tooth 14 on the pawl 7, the aperture 6 is formed and cannot be made larger, that is, once a tooth 15 of the first member 2 has engaged a tooth 14 of the pawl 7, the restraint cannot be opened, breaking the aperture 6, and releasing the member (not shown, e.g., wrist, ankle etc.). A biasing means 16 such as a spring or a magnet forces the teeth 14 of the pawl 7 to remain engaged with the teeth 15 of the first member 2. The aperture 6 can be made smaller my moving the first member 2 in the direction indicated to engage the next tooth 15 of the first member 2 with the tooth (or next tooth) 14 of the pawl 7. This action temporarily forces the pawl 7 against the biasing means 16 and away from the teeth 15 of the first member 2. This can be seen in FIG. 2.

To break the aperture 6, the teeth 14 of the pawl 7 may be disengaged from the teeth 15 of the first member 2 using a key (not shown) inserted into a keyhole 17 and rotated until it engages with a portion of the pawl 7, for example, a protruding member 18. Rotation of the key (not shown) forces the pawl against the biasing means 16, moving the pawl 7 away from the first member 2. Alternatively, the first member 2 can be release from the pawl 7 by continuing the constrict the aperture 6 my moving the first member in the free direction of movement indicated with an arrow on the second member 2, until the last tooth 15 of the first member 2 passes the last tooth 14 of the pawl 7. As the second member 2 is pushed to narrow the aperture 6, a tooth 14 of the pawl 7 pushes against a tooth 15 of the second member 2, which forces the pawl away from the second member (that is, against the biasing means 16), until it passes over the second member tooth 15 it was previously engaged with, and engages the next tooth 15. Once the last tooth of each has passed each other, the first member 2 is free to move about the pivot 4 past the second member 3.

### Double Lock Mechanism

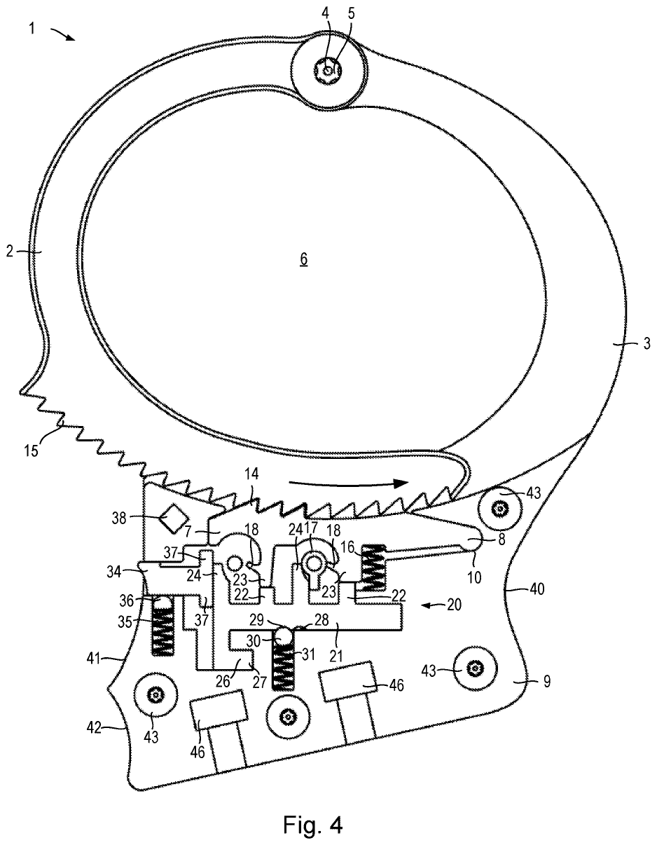

The restraint 1 may include a double lock mechanism 20. The double lock mechanism 20 has engaged and disengaged configurations or positions. Referring to FIGS. 1 to 3, the double lock is shown in the disengaged position. Referring to FIG. 4, the double lock mechanism 20 is shown in the engaged position.

When the double lock mechanism 20 is disengaged, the restraint 1 works in the way described above. When the double lock mechanism 20 is engaged, a slider 21 prevents the movement of the pawl 7 away from the first member 2, thus preventing the disengagement of the teeth 14 of the pawl 7 from the teeth 15 of the first member 2. The effect of this is to prevent movement of the first member 2 with respect to the pawl 7 and/or the second member 3, thus keeping the size of the aperture 6 constant.

The slider 21 may be predominantly “L” shaped. Along the length of the slider 21, there may be one or more protrusions 22 which are configured to engage with corresponding protrusions 23 of the pawl 7 when the double lock mechanism 20 is in the engaged position. The slider protrusions 22 and the pawl protrusions 23 are configured to bypass each other when the double lock mechanism 20 is in the disengaged position, allowing the pawl 7 to be disengaged from the teeth 15 of the first member 2.

The slider 21 may have key protrusions 24 which are configured to engage with a key inserted into a keyhole 17. When the key is rotated, it engages a key portion 24 on the slider 21 and moves the slider 21 from the engaged position to the disengaged position, allowing the pawl 7 to be moved away from the first member 2 when the first member 2 is moved to reduce the size of the aperture 6. The slider 21 may have second key-engaging protrusions 24 which can engage with a key when a key is inserted into the keyhole and rotated. Rotating the key to engage with the second protrusions 24 can also move the slider 21 into the engaged position.

The slider 21 may have a retaining member 26 protruding from the base of the “L” shape of the slider 21. The retaining member 26 may be configured to fit into a retaining member pocket 27 in both the first and second slider positions. This arrangement prevents the slider 21 from falling out if the pawl 7 is removed, or from the slider 21 being forced out by someone trying to gain unauthorised access to the restraint 1, for example, by using a shim, or using physical shock and/or momentum to dislodge one or more parts of the mechanism. Referring specifically to FIG. 4, although not necessary, the retaining member 26 fits within the retaining member pocket 27 when the slider 21 is in the second position, with the double lock mechanism engaged.

The slider 21 may have first and second detent mouldings 28, 29 suitable for receiving a slider detent 30. The detent 30 may comprise a spring plunger, for example, a ball nose plunger. The slider detent may be pushed into either the first or second slider moulding 28, 29 by a suitable biasing means 31, for example, a spring, or a magnet. The detent 30 sits in the first detent moulding 28 when the slider 21 is in the first position and sits in the second detent moulding 29 when the slider 21 is in the second position. Thus, the slider 21 cannot be shaken, for example, by being dropped on the floor, or hit against a wall or other solid object, or otherwise easily forced to engage or disengage the double lock mechanism 20.

### Double Lock Mechanism Engagement

A conventional double lock mechanism may be typically engaged using a pin on the bow or head of a key at the opposite end to the key bit. The pin may be inserted into the double lock mechanism which moves the slider of the conventional double lock mechanism into the engaged position, preventing the first member, or ratchet from moving in any direction with respect to the pawl, thus keeping the aperture at a constant size. A conventional double lock is disengaged by the insertion of a key, with the key being rotated (for example, rotated clockwise or counter-clockwise) so that the key bit engages a part of the slider to disengage the double lock. Alternately, a conventional double lock mechanism may be engaged using a lever either on the cheek of the restraint or sandwiched between the two cheeks of the restraint. However, in these examples, the double lock can be easily engaged by accident, resulting in a security risk for the user as the restraint may not have been adjusted to the correct size for the subject before the double lock is engaged.

The double lock mechanism 20 of the present restraint 1 can be engaged using a double lock engaging member 34, or “button” by pushing the slider 21 from the first slider position into the second slider position. Rather than the conventional way of engaging a double lock mechanism on a restraint, the button 34 does not require the use of a key or pin to engage the double lock mechanism 20. The button 34 is adjacent to, but separate from, the slider 21, that is, they are separate parts. A first end of the button 34 is configured to engage with the slider 21. A second end of the button 34 protrudes from the bracket and is accessible by a user and can be manipulated using, for example, a digit. Thus, the double lock mechanism may be engaged without the use of an external or separable component, such as a key or pin. This greatly enhances usability and reduces the chances of a subject (e.g., a wearer of a restraint) interfering with the restraint 1 while it is being applied to, for example, their wrists or ankles.

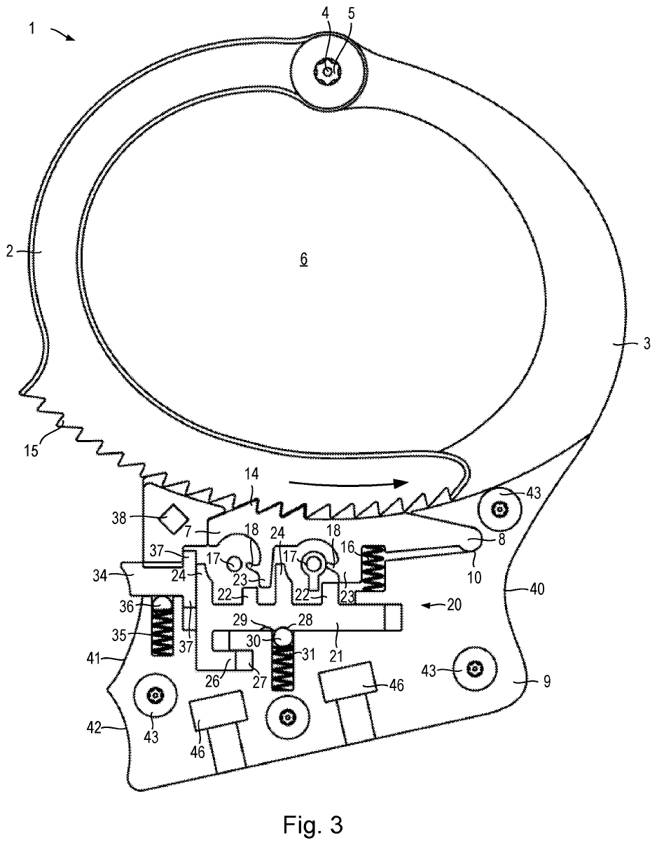

Referring again to FIGS. 1, 2, 3 and 4, the button 34 has first second, and third positions. FIGS. 1 and 2 show the restraint 1 with the button 34 in the first position and the double lock mechanism 20 disengaged. FIG. 3 shows the restraint 1 with the button 34 in the second position and the double lock mechanism 20 disengaged. FIG. 4 shows the restraint 1 with the button 34 in the third position and the double lock mechanism engaged. Referring specifically to FIG. 4, the button 34 is at least partially recessed into the bracket interposed or sandwiched between the sheets, or cheeks. This may provide a visual indicator to the user, subject, or third party, of the position of the button 34, and therefore whether the double lock mechanism 20 is engaged or not.

When the button 34 is in the second position, a force is applied to return the button 34 to the first position. This force may be applied by suitable biasing means 35, for example, a spring or a magnet, or may be applied by the way the user holds the restraint 1 in their hands, forcing the button 34 back to the first position. That is, if the button 34 is moved form the first position to the second position by a user, and then released, the button 34 will return to the first position by way of the biasing means 35.

While the button 34 is in the second position, there may be a moulding (not shown) on the button 34 which engages with a detent 36. A force may be required to overcome the detent 34 and move the button 24 from the second position into the third position. The force required to overcome the detent may be greater than the force required to move the button 34 from the second position to the third position in absence of the detent 36. The detent 36 may comprise a ball nose plunger or a spring plunger. The biasing means 35 providing force to push or return the button 34 from the second position to the first position may be the same spring 31 as that that holds the detent 36 in the moulding on the button 34. Alternatively, the force holding the detent 36 in the moulding may be a magnetic force.

Because the double lock mechanism is disengaged when the button 34 is in the first and second positions, and engaged when the button 34 is in the third position, the likelihood that the double lock mechanism 20 is accidentally engaged by a user is reduced as the user has to make two distinct actions by moving the button 34 from the first position to the second position and then overcome the force pushing the button 34 back to the first position and move the button 34 to the third position. Thus, the likelihood of the double lock mechanism being engaged prematurely, which may be dangerous, is reduced. Further, a user is able to quickly engage the double-lock mechanism 20 of the restraint 1, without having to change their hand position.

In some embodiment, the double lock mechanism may be engaged momentarily when the double lock engaging member is moved to the second position, before the disengaging again unless the double lock engaging member is moved to the third position. For example, the double lock mechanism may engage when the double lock engaging member is moved from the first position to the second position, but pushes the mechanism back or returns to the disengaged position unless the double lock engaging member is moved to the third position.

The button 34 can move from the first position to the second position, but not directly from the first position to the third position. That is, to move the button 34 from the first position to the third position, the button 34 has to be moved first to the second position. In the second position, the button 34 can move directly to the first or third position. In the third position, the button 34 can move directly to the second position, but cannot move directly to the first position, that is, to move the button 34 to the first position from the third position, the button 34 has to be moved first to the second position.

The angle between the path between the first position and the second position of the button 34 and the path between the second position and the third position may be less than 180°, that is, a change in direction of the button 34 may also be required to engage the double lock mechanism 20. The angle between the path between the first position and the second position and the path between the second position and the third position may be, 135°, 90°, 45°, or less than 45°. The angle may be greater than 10°.

The button 34 may comprise an anti-interference structure, for example, a block or blocking member 37, or a false tunnel (not shown), configured, or be shaped to prevent unauthorised interference with the double lock mechanism 20, for example by a shim being inserted into the double lock mechanism 20 to disengage, break or otherwise interfere with the mechanism 20. The button 20 may comprise more than one block or blocking member 37. A false tunnel (not shown) may be configured to direct a shim or other tampering device away from where it could interfere with the engaging member 34.

The action of engaging the double lock, i.e., moving the slider 21 into the second position may provide the user with an indication that the double lock mechanism has been engaged. This may be in the form of a sound, for example the click of the slider detent 30 being received by the second slider moulding 29, and/or an additional detent on the button 34 indicating that the button 34 has moved to the third position. The indication may be a haptic feedback indication provided to the user holding the restraint 1. Alternatively, or additionally, the feedback provided to the user may be, for example the sound may be a click, a beep, a snap, a clack or a clink. The sound may be provided by electronic means.

### Further Restraint 1 Features

The bracket 9 may have a square hole 38 machined, stamped, or cut through it.

There may be corresponding square holes in one or more of the first and second cheeks (see FIG. 5). A square-shaped pin may be inserted into the bracket 9 and one of both cheeks, preventing the rotation of the bracket 9 with respect to the cheeks, and second member. The square-shaped pin may also aid fastening the bracket 9 to the cheeks or second member.

The bracket 9 may have first, second and third mouldings 40, 41, 42 for receiving a user's thumb, index and middle fingers respectively. This arrangement allows the user to securely hold the restraint 1 in one hand while they are applying it to a subject or person, for example a perpetrator. The mouldings 40, 41, 42 may comprise or consist of a softer material than the restraint 1, for example, silica, rubber, plastic and the like.

The restraint 1 may have one or more fasteners 43 to fasten the cheeks (see FIG. 5) to the bracket 9. The fasteners 43 may be any suitable fastener, for example a rivet or a nut and bolt. The nut or bolt may be a security nut or bolt, for example having a security bit receiving recess. The fasteners 43 may be serviceable by the user. The fasteners 43 may be further held in place by an adhesive. The adhesive may be loosened by increasing the temperature (for example, by applying a heat gun, or a hair dryer on heat mode) of the adhesive, or by applying a solvent. This may increase the security of the restraint 1 by making it harder for a third party to loosen the fasteners 43.

The restraint 1 may further include one or more connector receiving portions 46 for receiving a restraint connector. There may be first and second connector receiving portions 46.

Referring to FIG. 5, a perspective view of an assembled restraint 1 is shown. The first member 2 of the restraint 1 may be formed from a single piece, for example a single steel or aluminium sheet which has been machined, stamped, forged, or cut (e.g. laser cut) into the appropriate desired shape. The second member 3 may be formed of first and second sheets 47, 48 which may be attached to the first member 2 at the pivot 4, using the pivot fastener 5. The first and second sheets 47, 48 may be arranged either side of the first member 2, sandwiching the first member between them. That is, the first member 2 may be interposed between the first and second sheets 47, 48. This arrangement may allow for the first member 2 to pass between the first and second sheets 47, 48 of the second member 3 when rotating about the pivot 4. The first and second sheets 47, 48 of the second member 3 may be attached to, or comprise respective first and second cheeks 49, 50. The first and second cheeks 49, 50 are arranged around the bracket 9, such that the bracket 9, including the double lock mechanism 20, is sandwiched between them.

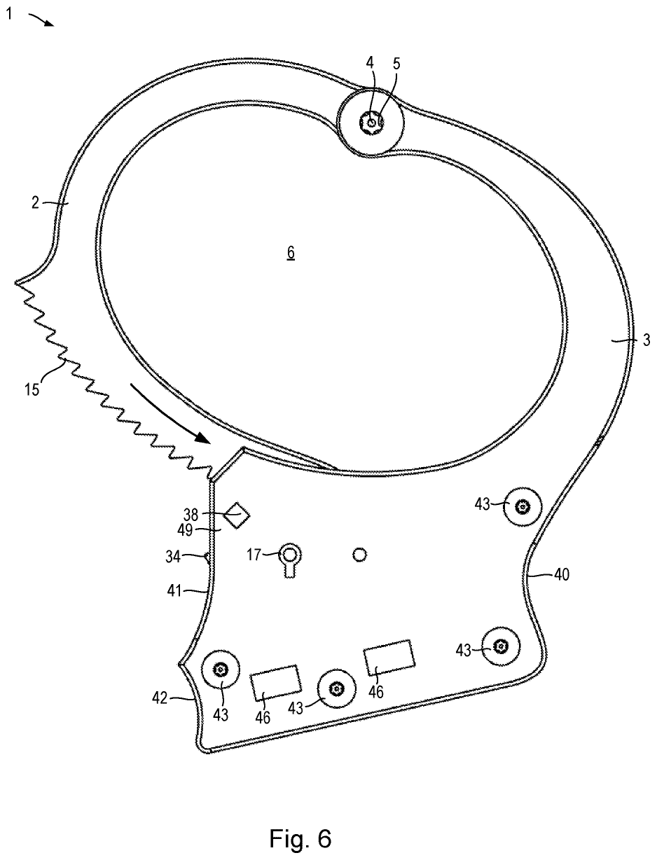

Referring to FIG. 6, when the double lock mechanism 20 of the restraint 1 is engaged, only the tip of the button 34 can be seen protruding from the bracket 9, or the first and second cheeks 49, 50. This may give a user a visual indication whether the double lock mechanism 20 is engaged or not. Alternatively, or additionally, the double lock mechanism 20 and/or bracket 9 may be arranged within a casing or sleeve.

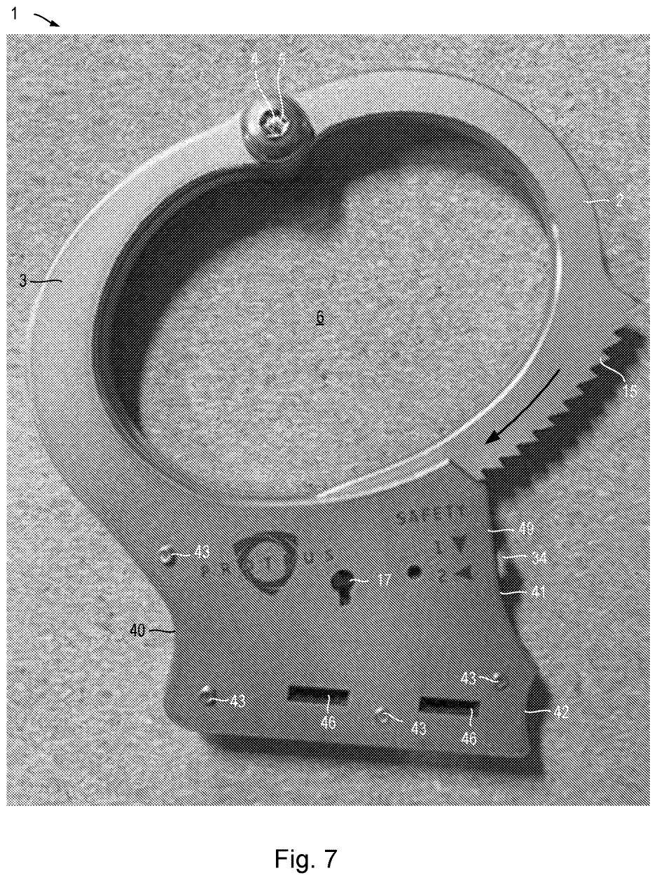

Referring to FIG. 7, a photograph of a restraint 1 is shown with the button 34 in the third position, therefore with the double lock mechanism 20 engaged.

### Dual Restraints 1

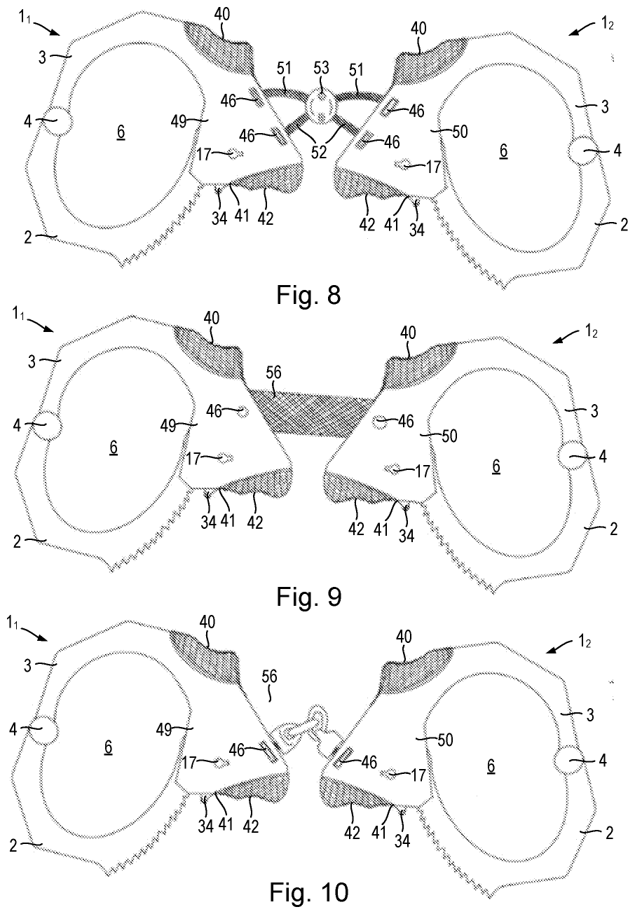

Referring to FIGS. 8 to 9, a first restraint 11 may be attached, connected or coupled to a second restraint 12 using a connector connected to at least one of the connector receiving portions 46 of each of the first and second restraints 11, 12. Referring specifically to FIG. 8, the first and second restraints 11, 12 are connected to each other by first and second cables 51, 52. The first and second cables 51, 52 may comprise or consist of metal fibres. The first and second cables 51, 52 may comprise woven polymer. The cables 51, 52 may comprise metal rope. The metal may be steel. The cable 51, 52 may be multi-strand cable, for example, wire rope. When the first and second restraints 11, 12 are laid flat, the first and second cables 51, 52 may be parallel with each other, or have an angle between each other of less than 10°. The first and second restraints 11, 12 may be connected to each other by a single cable 51.

The first and second cables 51, 52 may be connected to each other by a connector 53, for example, a connecting block. The connector 53 may be made from any suitable material, such as steel, aluminium, or a plastic. The connector may “pinch” the first and second cables 51 52 along their length, making the first and second cables 51, 52 appear to have an hourglass like shape when viewed from above with the first and second restraints 11, 12 lying flat on a surface. The first and second cables 51, 52 help prevent or reduce unintended twisting of each restraint with respect to each other. The connector 53 can also help prevent or reduce unintended twisting of each restraint with respect to each other.

The use of first and second cables eliminates or reduces the possibility of a wearer (e.g. subject) of the restraints 1₁, 1₂ being pinched between the chain of a traditional restraint (e.g., a pair of handcuffs) and the restraint body. Likewise, the first and second cables can help reduce the likelihood of the user having their hands, digits or skin trapped or pinched by a part of the pair of restraints 1₁, 1₂.

The first and second connected restraints 11, 12 may be configured such that the first and/or second cables 51, 52 are configured such that when the apertures 6 formed by the first and second restraints 1₁, 1₂ lie on a single plane, or at an angle of less than or equal to 15°, and when a force is applied to either restraint 1, the angle between the plane of the first restraint aperture 61 and the second restraint aperture 62 is less than 225°, less than 90°, or less than 135°, less than 45°, less than 30°or less than 10°. Thus, the pair of restraints 1₁, 1₂ may have a predictable position with respect to each other and allow the safe and efficient fitting of the restraints 1 to, for example, a pair of wrists.

Referring to FIG. 9, the first restraint 1₁ may be connected to the second restraint 1₂ by a spring 56. The spring 56 may be a coiled spring or may be a sheet spring. The spring 56 may be a leaf spring comprising overlapping layers of spring sheets. The spring sheet may be a spring-steel sheet. The spring 56 may be encased in a sheath, for example a non-metallic sheath or a polymer sheath, for example polyvinyl chloride or nylon.

For example, the cable connector 53, or connector spring 56 may be configured to provide a force such that the plane of the aperture of the first restraint 1 is less than or equal to 15° from the plane of the aperture formed by the second restraint.

The angle between the plans of the apertures of the first and second restraints may be less than or equal to 10°, 8°, 5°, or the angle may be equal to 0°, that is, the apertures are on the same plane.

Thus, when a user applies a first restraint to a wrist, ankle, by letting go of the second restraint, the cables or spring move the second restraint into a position which may allow for easy attachment to the second wrist or ankle. Thus, the risk of injury to the user and the subject is reduced as the user does not have to retrieve the second restraint and bring it into the appropriate position. Likewise, if the subject is struggling, the user may have to use their hands to restrain the subject and thus may be unable to move the second restraint into position. When using restraints connected by a chain, there is an increased risk of the user and/or subject's skin being pinched while manipulating the restraints.

The pair of restraints may be configured to provide a force such that the plane of the aperture of the first restraint is less than or equal to 15° from the plane of the aperture formed by the second restraint while no external force is being applied to either the first or second restraint, for example, by a user manipulating one of the restraints.

The force that returns the restraints to a roughly “flat” orientation (where the apertures lie in the same plane), may also allow for the restraints to be stored folded against each other, as they will return to a usable orientation when removed from a holder or storage for use.

Thus, the pair of restraints have a predictable position with respect to each other, and allow the safe and efficient fitting of the restraint to, for example, a pair of wrists.

Referring to FIG. 10, the first restraint 11 may be connected to the second restraint 12 by one or more chain links 57.

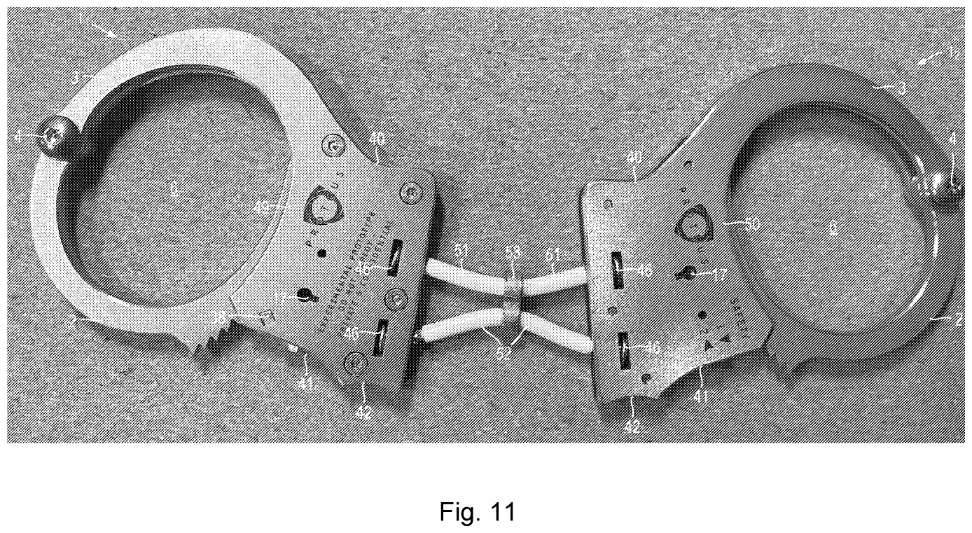

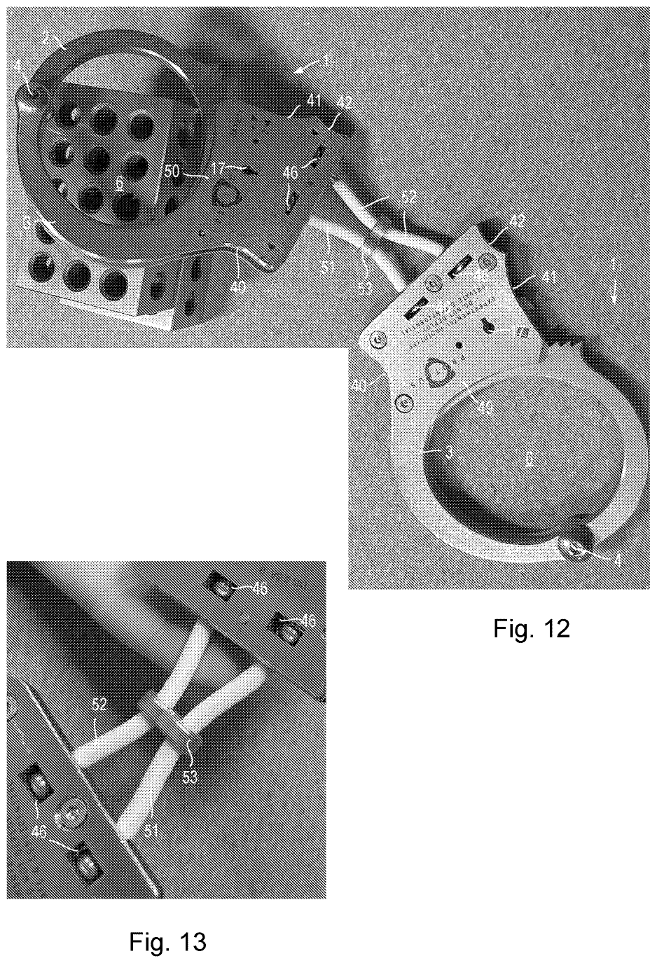

Referring to FIGS. 11 and 12, photographs of the pair of first and second restraints 1₁, 1₂ in FIG. 8 are shown. FIG. 11 is a photograph of a first side of the first and second restraints 1₁, 1₂, and FIG. 12 is a photograph of a second side of the first and second restraints 11, 12. Referring also to FIG. 13, a photograph showing the detail of the connecting cables 51, 52, is shown. The cables 51, 52 may be coated, for example by a polymer. Suitable polymers for coating may include polyvinyl chloride (PVC), nylon (polyamide), fluorinated ethylene propylene (FEP), polyurethane, polyethylene, polytetrafluoroethylene (PTFE), or other suitable polymers. The cables 51, 52 may be coated in silicone. The coating may reduce the friction of the cables, making them easier to use for the user. The coating may also help protect the cable material from wear and tear and exposure to the elements.

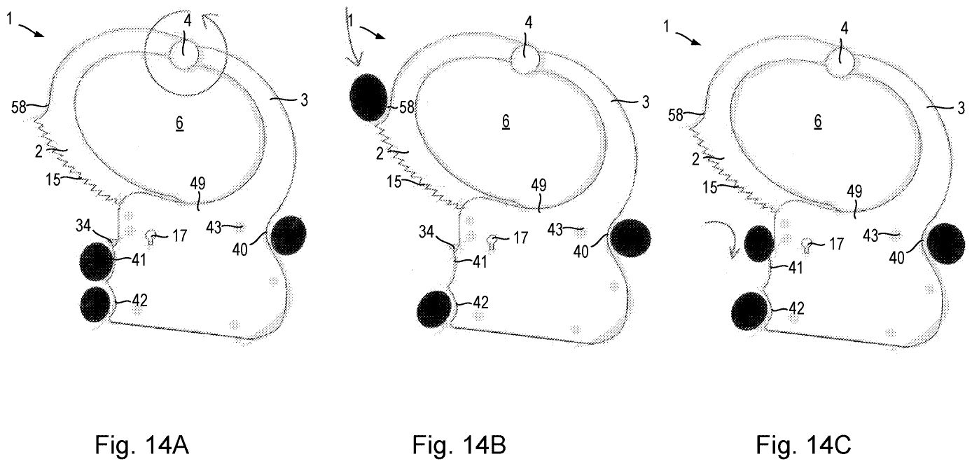

Referring to FIGS. 14A to 14C, the first, second and third mouldings 40, 41, 42 for receiving a user's thumb, index and middle fingers respectively allow a user to comfortably hold the restraint 1 in one hand and manipulate the restraint 1 to apply it to a subject (e.g., their wrist or ankle) or suitable object, for example a post.

Referring in particular to FIG. 14A, a user comfortably holds the restraint 1 in one hand using three digits. Referring in particular to FIG. 14B, to apply the restraint 1 to a subject or object, the aperture 6 can be opened up by the user moving their index finger to a moulding 58 on the first member 2 pushing the first member through the first and second member sheets 47, 48. The restraint 1 can then be closed around a person's appendage or an object and the first member 2 can be engaged with the pawl 7. Referring in particular to FIG. 14C, once the desired aperture 6 size has been reached, the user can then use their index finger to engage the double lock mechanism 20 using the button 34.

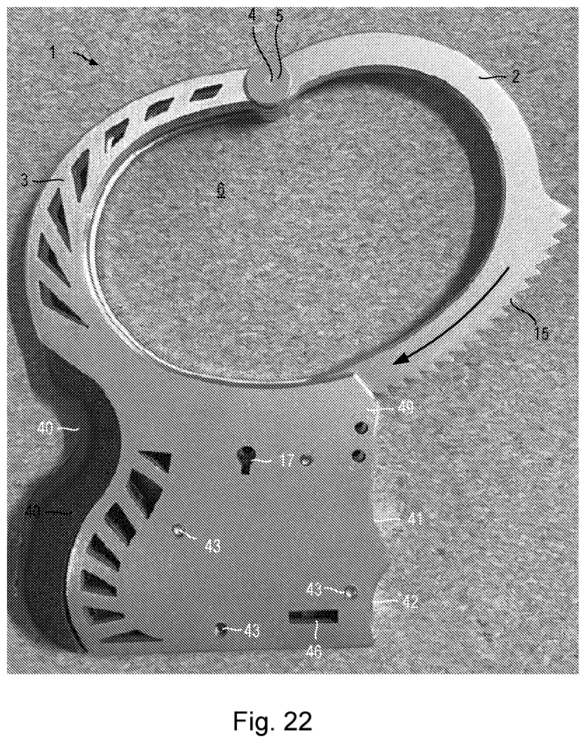

Padding, for example in the form of a polyurethane rubber grip or other suitable material may be added to the restraint 1, for example at the first, second and third mouldings 40, 41, 42, to improve the restraint's 1 ergonomics and/or comfort while being held be a user (see also FIG. 22).

### Electronic Handcuffs

Many restraints currently available on the market are simply mechanical devices, with no or limited means of recording what states the restraint has been in, or recording any other information input or pertinent to them. For example, on conventional restraints, there is no way of knowing what the size of the aperture 6 has been over a period of time, or whether the restraints have been used. Other than identifying mechanical stress on the mechanisms, it is difficult to identify whether the restraint has been tampered with, or an attempt at tampering has occurred.

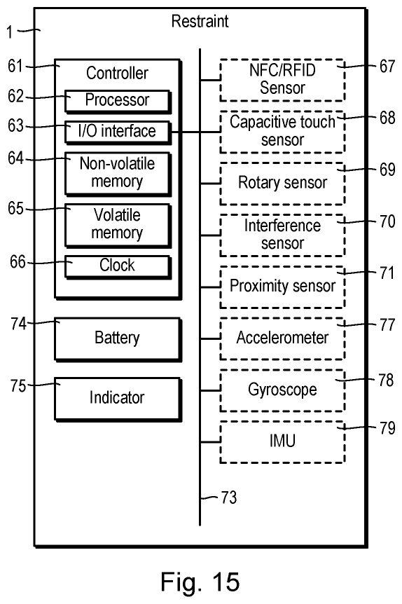

Referring to FIG. 15, the restraint 1 has a controller 61, the controller 61 may compose a processor 62, for example a microprocessor, an input/output interface (I/O interface) 63, non-volatile memory 64, volatile memory 65, and a clock 66. The restraint 1 may include a plurality of sensors. The restraint 1 includes a sensor 67, 68 to detect when the restraint 1 is removed from a restraint holder (not shown). The restraint holder may be, for example a case attached to a user's belt. The case may have a corresponding sensor where necessary. The sensor 67, 68 for detecting whether the restraint 1 has been removed from the restraint holder may be, for example, a near field communication (NFC) sensor 67, a radio frequency identification (RFID) sensor 67, or the sensor may be a capacitive touch sensor 68. The capacitive touch sensor 67 may be activated when the restraint 1 is touched by the skin, or other suitable surface of the user, for example the bare hands or digits of a user. Additionally, or alternatively, the sensor may be or comprise a magnetic loop, or a circuit breaker. When the sensor 66, 67 indicates the restraint 1 has been touched or removed from the restraint holder, the time may be recorded on the non-volatile memory 64 of the controller 61 using the clock 66. The time the restraint 1 was handled or removed from a restraint holder may then be referenced later, for example, by law enforcement authorities, the courts, or other third parties.

The input/output interface 63 may be a wireless interface, for example, Bluetooth or Wi-Fi, or cellular. The interface 63 may be configured to send data (for example data collected from one or more sensors 67, 68, 69, 70, 71, 77, 78, 79) to a device (not shown) off the restraint, for example a computer, a phone, a server (e.g., a cloud server).

The restraint 1 may also include a rotary sensor 69 arranged to record the relative angle between the first member 2 and the second member 3 (i.e., the angle of rotation of the first member with respect to the second member). With the relative angle of the first member 2 with respect to the second member 3, the size of the aperture 6 may be determined at any given time. The rotary sensor 69 may be, for example, a magnetic sensor, for example, a Hall Effect switch, a Hall Effect latch, a magnetoresistive sensor, or a Reed switch. The rotary sensor 69 may be a potentiometer-based sensor, a rotary encoder, or a rotary inductive encoder. The rotary sensor 69 may be a rotary variable differential transformer. Thus, the restraint 1 may be operated at extremely low power as magnetoresistive sensors may be operated at extremely low power. Preferably the magnetoresistive sensor is a tunnelling magnetoresitive sensor.

Alternatively, or additionally, the sensor may be configured to count the number of ratchet teeth have moved past the pawl, thus detecting movement in the restraint, or using the tooth count to determine the size of the aperture. The sensor may sense motion of the pawl as it oscillates up and down as is engages the teeth of the ratchet, rather than the rotation of the ratchet about the aperture. The sensor may be a magnetic sensor arranged to be in, or close to, the ratchet or the pawl and configured to detect movement of either the ratchet or the pawl. The sensor may comprise an embedded magnet(s) or use induction to detect the metal of a ratchet (first member) teeth as they pass by a pawl. The sensor may be an optical sensor configured to detect the movement of one or more parts of the restraint mechanism.

The restraint 1 may include an interference sensor 70 configured to detect electrical or magnetic interference, for example, from a third party attempting to disrupt, corrupt, or break the other sensors 67, 68, 69, the memory 64, 65 or other components of the controller 61 using a device to produce a strong magnetic field. Alternatively, a magnetic bracelet or clasp, or other magnetized wearable item such as a wrist strap may inadvertently interfere with the sensors (e.g., NFC/RFID sensor 67, capacitive touch sensor 68, rotary sensor 69 and/or volatile or non-volatile memory 64, 65 on the restraint.

The interference sensor 70 may record the presence or proximity of a magnet near the restraint 1. The interference sensor 70 may be connected to a second, or backup, controller (not shown), which may have additional shielding, for example electromagnetic shielding, to prevent external interference. The second controller may include the same components as the first controller 61. The controller may be configured to receive a signal form the interference sensor 70, and to record that an interfering magnetic field has been detected, and the time the magnetic field was detected.

The restraint 1 may also have a second or backup magnetic sensor that detects the opposite pole of a magnet in the ratchet 2. This allows the restraint 1 to resist and detect errors or interference caused by external magnetic fields. For example, two analogue magnetic sensors, one configured to track the north pole of a magnet and one configured to track the south pole of the magnet. As the magnet rotates with the ratchet, each sensor detects a sinusoidal pattern as the magnetic pole is closer or farther from the sensor package. Since both sensors are contained within the same chip (i.e., they are in the same location), the sinusoidal signals are offset by 180 degrees. In the case of interference, this pattern will be interrupted, and a phase shift will be present and can be detected. Thus, if a situation arises where the two signals do not align with each other, there is interference from an external magnetic source.

The double lock mechanism 20 of the restraint 1 may include a proximity sensor 71 configured to determine whether the slider 21 is in the engaged or disengaged position. The proximity sensor 71 may be any suitable sensor, for example, an NFC, RFID, or magnetic sensor, for example, a Hall Effect switch, a Hall Effect latch, a magnetoresistive sensor, or a Reed switch. The restraint 1 may record the position of the proximity sensor 71 in the memory, and therefore create and maintain a record of when and whether the double lock mechanism 20 was engaged or disengaged. The proximity sensor 71 may detect whether a magnet 72 arranged or embedded in the slider 21, for example at the opposite end of the slider to the double lock engaging member 34. When the slider 21 is in the engaged position, the proximity sensor 71 detects the magnet 72 and records that the double lock mechanism is engaged.

Any one of the sensors on the restraint 1 may send signals to the controller 61 via a bus 73 connected to the I/O interface 63 and record their state along with the time the state occurred in the non-volatile memory 64. In some instances, the processor 62 may filter or smooth the signals provided form the sensors. A battery 74 may provide the controller 61 and/or sensors with power.

The controller 61 may start recording the output(s) from the sensor(s) when the sensor 67, 68 indicated that the restraint 1 has been touched or been removed from a restraint holder. Recording may stop after a period of inactivity, for example a predetermined number of hours, or when a second signal is received indicating that the restraints are back in the restraint holder, or the restraints are no longer in contact with human skin or another suitable capacitive producing member. The predetermined number of hours of recording may begin after the first or last recording from the capacitive touch sensor. An indicator 75 may show or flag whether the restraint 1 is recording outputs from the sensors. The indicator 75 may be, for example, a light emitting diode (LED), but other suitable indicators may be used. The battery 74 may also provide power to the indicator 75. The indicator may also indicate whether the battery power is below a threshold, for example, 20%, 10% or 5% of power remaining. The indicator 75, may have different colours or modes (e.g., blinking or flashing, or steady state), to indicate different sensor or battery conditions.

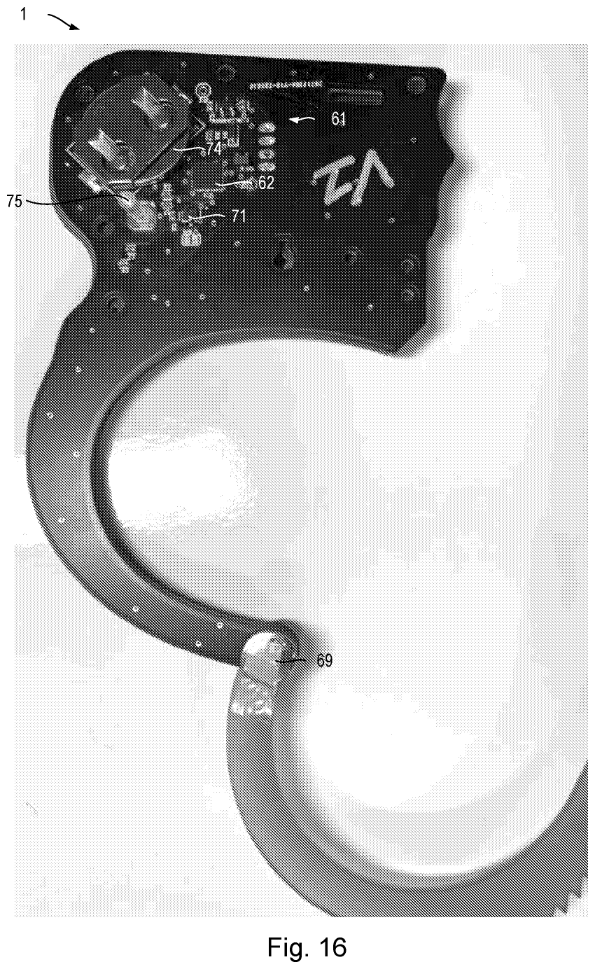

Referring to FIG. 16, a photograph of a restraint 1 comprising a controller 61, processor 62, battery 74, and indicator 75. The controller 61 and battery 74 may be housed in the bracket 9, or between the first and second cheeks 49, 50. The rotary sensor 69 is arranged to be in the pivot point or pivot portion 4 of the restraint 1.

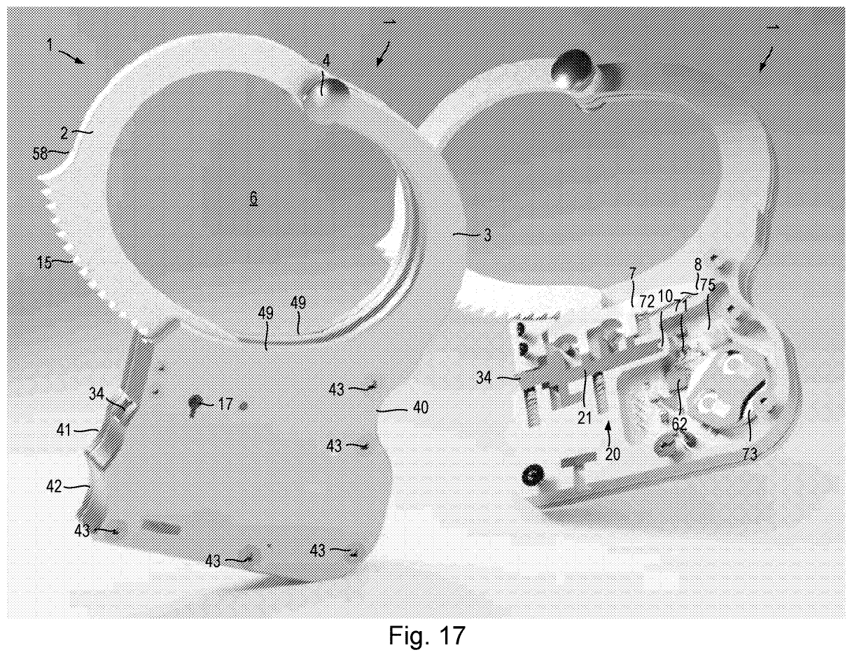

Referring to FIG. 17, an perspective render of a model of the restraint 1 comprising a controller 61, processor 61, batter 73, and indicator 75 is shown along with the double lock mechanism 20 and the double lock engaging button 34.

The restraint 1 may include a movement sensor 77, 78, 79 such as an accelerometer 77, a gyroscope 78, or an inertial measuring unit 79 which can detect when the restraint is in motion.

The processor 62 may receive inputs from multiple sensors, and/or a timer, and process these to determine the state of the restraint 1 at any given time. For example, motion information from the sensor(s) may indicate that the restraint is in use, that is, being handled by a user to apply to a subject, or secure object, or are being worn by a subject, or the motion information may indicate that the restrains are in a holder or holster of the user ready for deployment. These states can be recorded in the memory 64 and accessed later, for example by a relevant authority such as a court or a police department. The touch sensor 68, that is, whether the restraint 1 is being touched by a user or subject, may provide the greatest weight when processing the sensor information.

### External Ratchet 2 Padding

Some restraint-or handcuff-related injuries can occur caused by overtightening of the restraint 1, however, many are caused by the ratchet 2 (first member) impacting a subject's wrist during application. Wrists include multiple small bones and protruding bone features which are not protected by much soft tissue. This leaves the bones of the wrist vulnerable to fracture from contact with the outer surface of the ratchet 2 during handcuffing, or the application of the restraint. Many cases of such injuries caused by the ratchet 2 impacting the wrist, for example during arrest, are recorded in medical literature. In particular, the radial styloid is vulnerable to fracture during restraint or handcuff application.

Conventional handcuff and restraint designs do not include any means to minimize damage from the outer surface of the ratchet. Typically, the outer surface of the ratchet 2 is unpadded metal with a convex contact point. This design minimizes contact surface area and maximizes the energy transferred from the restraint or handcuff into the wrist during application, increasing the likelihood of fracture.

Ideally, a user will place the ratchet 2 next to the subject's wrist and pushes into the wrist, causing the ratchet 2 to swing around at the pivot 4 and engage the pawl 6. When done this way, the ratchet 2 does not pose a high risk of injury. However, in real life scenarios, the subject may be moving or actively resisting, for example while resisting arrest. This can make placing the ratchet 2 against the subject's wrist without impacting the wrist difficult. Further, manual dexterity of the user can be compromised by cold temperatures, mental or physical fatigue, and anxiety—all conditions that user, e.g., law enforcement officers, may deal with during application, for example an arrest. In combination, these factors mean conventional designs sometimes cause wrist damage during application, even by practiced users.

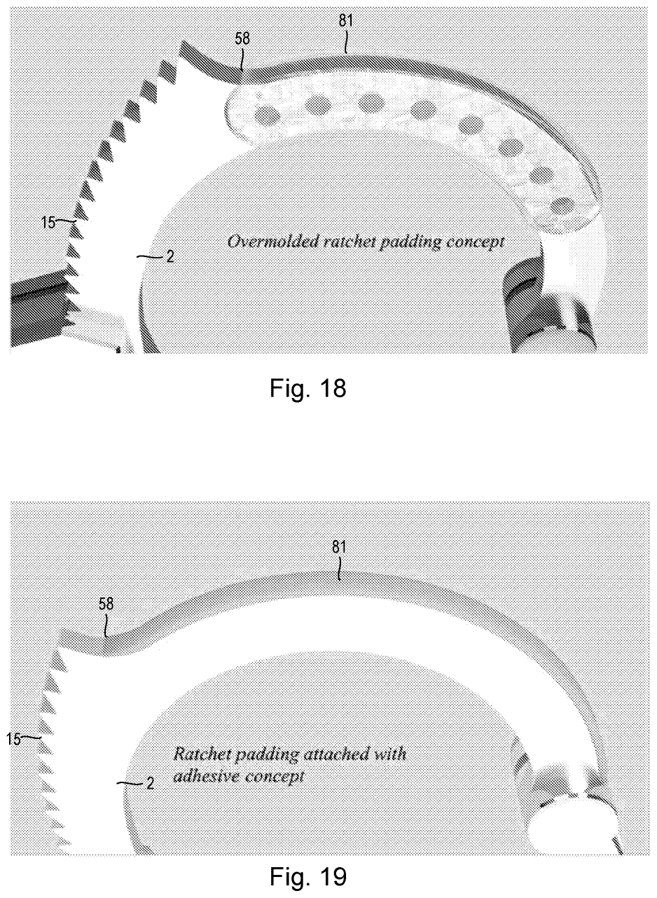

Referring to FIG. 18, to counteract these problems, padding 81 can be added to the ratchet 2 at the area where the ratchet 2 normally contacts a subject's wrist during application. This padding 81 can reduce the likelihood of damage caused by the ratchet 2 impacting a subject's wrist during application. The padding 81 may be applied to the non-toothed portion of the ratchet 2. The padding 81 may be overmoulded, or two-shot moulded, and may surround the ratchet 2.

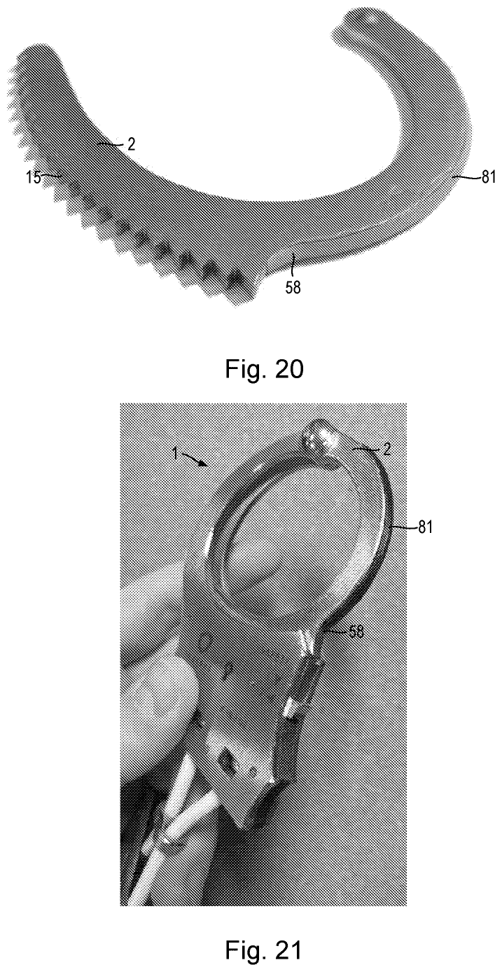

Referring to FIG. 19, a render of padding 81 adhesively attached to the ratchet 2 is shown. Referring to FIGS. 20 and 21, photographs of padding 81 adhesively attached to the non-toothed portion of the ratchet 2 are shown.

### Lightweight Restraint 1

### Skeletonized Restraint 1

Using finite element analysis (FEA), certain internal areas of the restraint 1 were identified as not experiencing significant stress concentration under load. A skeletonized version of the restraint 1 features cut-outs that reduce the overall weight of the restraint 1 without compromising the restraint's 1 strength. For example, the second member may comprise a plate with shapes, for example triangles, removed from it, forming a skeletonized, or scaffold-like structure. The second member may comprise a series of linear or curves struts or members connected at nodes to form a skeletonized or scaffold-like structure.

Referring to FIG. 22 a photograph of a skeletonized restraint 1 shows a conventional restraint having portions of the second member 3 and portions of the first and second cheeks 49, 59 and the bracket 9 removed resembling a “skeletonized” version of portions of the restraint. The removal of this material reduced the mass of the restraint, and therefore makes the restraint 1 lighter and may make the restraint 1 easier to manipulate by a user in one hand.

### Non-metallic Restraint 1

Alternatively, or additionally, the restraint 1 may include non-metallic components, or components which comprise non-metallic material. For example, the bracket 9 or the cheeks 49, 50 may include non-metallic material. Non-metallic material may include carbon fibre, plastic, acrylonitrile butadiene styrene (ABS), or bioplastic. The non-metallic material may consist of carbon fibre. The carbon fibre may be a carbon fibre composite. For example, a polyamide. The carbon fibre may have short, non-woven carbon fibres. The carbon fibre may be woven carbon fibre.

Preferably, the cheeks 49, 50 are made form a non-metallic material, and the bracket (for example comprising the double lock mechanism) comprises metallic components interposed between the first and second cheeks 49, 50. Carbon fibre composite has high tensile strength, and is therefore ideally suited to being used in the outer components of the restraint. Components of the bracket, and the double lock mechanism, including detents, may comprise acrylonitrile butadiene styrene (ABS), bioplastic, other plastics, or other non-suitable metallic material.

Including non-metallic components in the restraint 1 may reduce the mass of the restraint, and make it easier for a user to handle, especially where repeated handling is required. The reduced mass may also reduce injury to both the user, e.g., in case the restraint is used as a weapon by a subject, or from repetitive use, and also of the subject, where wearing a lower-mass object may reduce strain applied to, for example, the wrist, arms, ankles, or legs.

### Modifications

It will be appreciated that various modifications may be made to the embodiments hereinbefore described. Such modifications may involve equivalent and other features which are already known in the design and implementation of double lock mechanisms, restraint(s), handcuffs, shackles, manacles and the like, and component parts thereof and which may be used instead of or in addition to features already described herein. Features of one embodiment may be replaced or supplemented by features of another embodiment.

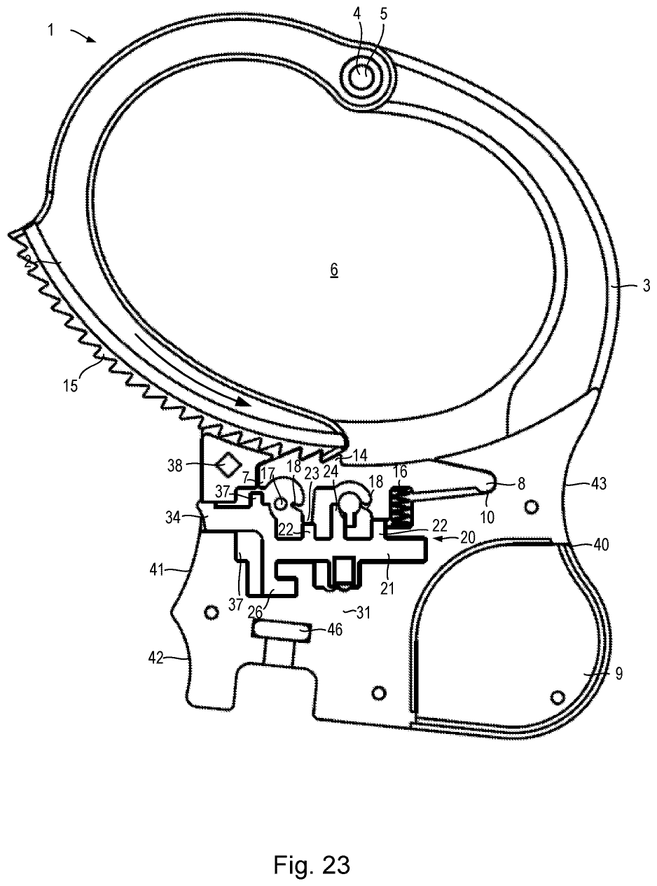

Referring to FIG. 23, the slider 21 and the double lock engaging member 34 (also referred to as a button) may be fused together, connected, or formed from a single piece. The force applied to return the double lock engaging member 34 to the first position when in the second position may be applied from a ball detent (not shown) and a ball detent spring (not shown) which pushes against the slider 21 in the direction of the pawl 7. Alternatively, the force applied to return the double lock engaging member 34 to the first position when in the second position may be from the compliant nature of either the combined double lock enraging member 34, and slider 21, or the combined engaging member slider component. If a combined engaging member slider component is used, the slider 21 will have a third position when the engaging member 34 is in the first position, and the double lock mechanism 20 is not engaged.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A double lock mechanism for a pawl, the mechanism comprising:
a double lock engaging member configured to move from a first position to a second position, and from the second position to a third position,
wherein the double lock mechanism is configured such that when the double lock engaging member is in the second position, a force is applied to return it to the first position,
wherein the double lock mechanism is disengaged in the first position, and engaged in the third position.

2. The double lock mechanism according to claim 1, wherein the angle between a path between the first position and the second position and a path between the second position and the third position is greater than 0° and less than 180°.

3. The double lock mechanism according to claim 1, wherein:
in the first position, the double lock engaging member can move to the second position, but not to the third position;
in the second position, the double lock engaging member can move to the first or third position; and
in the third position, the double lock engaging member can move to the second position, but not to the first position.

4. The double lock mechanism according to claim 1, the mechanism comprising:
a slider having disengaged and engaged positions, wherein in the disengaged position the double lock mechanism is not engaged and in the engaged position the double lock mechanism is engaged, wherein the double lock engaging member is configured to move the slider into the engaged position when it is moved from the second position to the third position.

5. The double lock mechanism according to claim 4, the mechanism comprising:
a detent configured to retain the slider in the engaged and/or disengaged positions.

6. The double lock mechanism according to claim 1, the mechanism comprising:
a detent configured to retain the double lock engaging member in the first and/or third position.

7. The double lock mechanism according to claim 1, wherein the mechanism is configured to generate a sound when the double lock engaging member is moved into the third position.

8-9. (canceled)

10. The double lock mechanism according to claim 1, wherein the double lock mechanism is part of a restraint having first member connected to a second member at a pivot, the first and second members configured to engage with each other to form an aperture.

11. A pair of restraints comprising first and second restraints connected to each other, wherein each constraint comprises:
a double lock mechanism for a pawl, the mechanism having
a double lock engaging member configured to move from a first position to a second position, and from the second position to a third position,
wherein the double lock mechanism is configured such that when the double lock engaging member is in the second position, a force is applied to return it to the first position,
wherein the double lock mechanism is disengaged in the first position, and engaged in the third position.

12. A restraint for applying to a wrist or an ankle comprising:
a sensor configured to detect when the restraint is in use.

13. The restraint according to claim 12, further comprising:
a first member connected to a second member at a pivot, the first and second member configured to engage with each other to form an aperture.

14. The restraint according to claim 13, wherein the sensor is configured to detect movement of the first member with respect to the second member.

15. The restraint according to claim 13, or wherein the sensor is configured to detect the angle of rotation of the first member with respect to the second member.

16. The restraint according to claim 12, wherein the sensor comprises a capacitive touch sensor configured to detect the presence or absence of the touch of a user.

17. The restraint according to any of claim 12, wherein the sensor is a sensor configured to detect movement of a component of the restraint.

18. The restraint according to claim 12, further comprising a double lock engaging member for a double lock mechanism for a pawl, wherein the sensor is configured to detect movement of the double lock engaging member.

19. The restraint according to claim 12, wherein the sensor comprises one or more of:
an accelerometer;
a gyroscope; and
an inertial measuring unit.

20-21. (canceled)

22. The restraint according to claim 12, wherein the sensor is configured to detect when the restraint is removed from a restraint holder.

23. The restraint according to claim 22, wherein the sensor is near field communication sensor, or a radio frequency identification sensor.

24. The restraint according to claim 12, further comprising:
a controller;
a timer; and
memory,
wherein the controller is configured to, on detection that the restraint is in use or has been removed from the restraint holder, to record the time, and/or the state of the sensor.

25-40. (canceled)
